(19) United States
(12) Patent Application Publication
(10) Pub. No.: US 2009/0244020 A1
(43) Pub. Date: Oct. 1, 2009

(54) BROWSING RESPONSIVE TO SPEED OF GESTURES ON CONTACT SENSITIVE DISPLAY

(75) Inventor: Fredrik Sjolin, Ronneby (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: UIQ TECHNOLOGY AB, Ronneby (SE)

(21) Appl. No.: 12/298,177

(22) PCT Filed: Jun. 26, 2007
(86) PCT No.: PCT/EP07/05636

§ 371 Date: Oct. 23, 2008

(30) Foreign Application Priority Data
Jun. 26, 2006 (GB) 0612624.7

(51) Int. Cl. G06F 3/041; G06F 3/033

(52) U.S. Cl. 345/173; 715/863

(57) ABSTRACT

The present invention concerns an electronic device and a method and a computer program product for operating an electronic device by means of contact. The device includes a display (120) for receiving contact between a human finger (230) or another item and a contact sensitive area (220) on the display; a sensing unit for registering the contact with the display and for converting the contact into electrical signals and a processing unit for calculating coordinates associated with the display (120) from the electrical signals received from the sensing unit and for comparing the received coordinates with predefined coordinates stored in a memory indicative of gesture sensitive areas on the display. The processing unit is adapted for initiating a browsing of an electronic document (200), where the browsing is responsive to the speed with which the gesture is performed by a human finger or another item in contact with the display.

### TECHNICAL FIELD

The present invention is related to the field of operating electronic devices by means of gestures. More particularly, the present invention concerns an electronic device and a method and a computer program product for operating an electronic device by means of contact.

### BACKGROUND OF THE INVENTION

Today it is becoming increasingly popular to operate electronically devices, such as portable media players, cell phones, GPS (Global Positioning System) navigation devices and computer monitors by means of touch.

Especially in the case of portable media devices and cell phones certain movements by the user finger over a user interface field lead to certain reactions by the device, such as increasing or decreasing the sound volume or scrolling a list of items up or down.

In recent years web browser programs have been introduced to the market which may receive so called “mouse gestures”, meaning that a certain movement of the mouse may signal the web browser to go back or to go forward one web page.

It would be desirable however to provide an electronical device where the gesture operating function is more interactive with the content shown on a computer or mobile terminal screen or a display and which can be used to operate different functions and applications in the electronical device.

The present invention aims at obviating at least some of the disadvantages of known technology.

### SUMMARY OF THE INVENTION

A first aspect of the present invention is directed towards an electronic device comprising:
a display for receiving contact between a human finger or another item and a contact sensitive area on the display;
a sensing unit for registering the contact with the display and for converting the contact into electrical signals;
a processing unit for calculating coordinates associated with the display from the electrical signals received from the sensing unit and for comparing the received coordinates with predefined coordinates stored in a memory indicative of gesture sensitive areas on the display wherein
   the processing unit is adapted for initiating a browsing of an electronic document, wherein
   the browsing is responsive to the speed with which the gesture is performed by a human finger or another item in contact with the display.

A second aspect of the present invention is directed towards a method for operating an electronic device by means of contact comprising the steps:

a) registering a contact between a human finger or another item and a contact sensitive display;
b) calculating coordinates on the contact sensitive display from the contact registered;
c) comparing the calculated coordinates with predefined coordinates associated with a gesture sensitive area on the contact sensitive display;
d) detecting the speed of movement with which a gesture performed by a human finger or another item is performed over the surface of the display and;
e) initiating a browsing of an electronic document, wherein the browsing is responsive to the speed with which the gesture is performed on the display.

A third aspect of the present invention is directed towards a computer program for operating an electronic device sensitive to contact comprising instruction sets for:

a) registering a contact between a human finger or another item and a contact sensitive display;
b) converting the contact registered into coordinates on the contact sensitive display;
c) comparing the converted coordinates to predefined coordinates associated with a gesture sensitive area on the contact sensitive display;
d) detecting the speed of movement with which a gesture performed by a human finger or another item is performed over the surface of the display and;
e) initiating a browsing of an electronic document, wherein the browsing is responsive to the speed with which the gesture is performed on the display

The present invention allows a user to use a gesture and speed of gesture recognizing function to interactively flip through documents, web pages, lists and other types of information. In this way reading of documents can be done in a more natural way to users of such devices. Thus the present invention allows a user to read documents on a display in a way that is similar to reading of paper documents. The invention is therefore user-friendly.

### BRIEF DESCRIPTION OF THE DRAWINGS

FIG. 1 illustrates an electronic device according to one embodiment of the present invention.

FIG. 2 shows one possible application of the present invention on the electronic device from FIG. 1

FIG. 3 illustrates the method steps according to one embodiment of a method of the present invention.

### DETAILED DESCRIPTION OF PREFERRED EMBODIMENTS

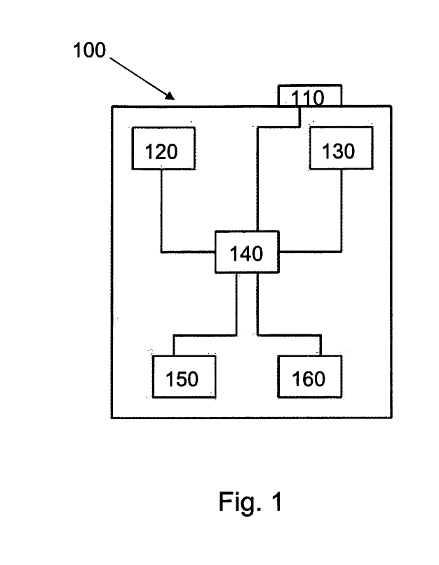

FIG. 1 illustrates an electronic device 100 for recognizing gestures performed by a user, where the gestures may be performed by using fingers, pens, or other items exerting pressure or touch onto a touch-sensitive display 120 of the electronic device 100.

An electronic device may here with advantage be a portable electronic device, like a palm top or a lap top computer. It may also be a portable communication device, which may be such computers having communication ability or it may be a cellular phone.

Furthermore, the electronic device comprises a user interface 130, a sensor unit 150 and a memory 160 all connected to a processing unit 140. Also, the electronic device may additionally comprise a receiver and/or transmitter 110 if the electronic device is intended to communicate in a wireless communication network.

If that is the case, the electronic device 100 may via its receiver/transmitter 110 may receive electronic documents, web pages and other types of information which may be of interest to a user using the electronic device 100. Also, the electronic device 100 may via the receiver/transmitter 110 transmit information to other parts of the wireless communication network, such as requests for downloading additional electronic documents, web pages or reviewed documents read in the electronic device 100.

The function of the display 120 of the electronic device is to present information in the form of documents, graphics, web pages and other information to the user, while the display 120 at the same time is touch and/or pressure sensitive.

Thus a user may, by pressing or touching the display 120, communicate with the electronic device and the documents, web pages and other types of documents displayed thereon.

Touching or pressing the display 120 of the electronic device 100 will trigger a response from the sensing unit 150 which will convert the touch or press into electrical signals. It may be added here that the sensing unit 150 may comprise capacitive, resistive, surface acoustic wave sensing units or other types of sensing units known to the skilled person.

While a resistive sensing unit would provide cost advantages, capacitive and surface acoustic wave based sensing units would have the advantages of better visibility of the displayed information due to a high amount of light reflected from the display and avoidance of mechanical pressure on the display.

The processing unit 140 is adapted for sending documents, web pages, lists and other electronical information in a format presentable on the display 120. Also, the processing unit is adapted to convert the electrical signals received from the sensing unit as a consequence of pressing or touching the display 120 into display coordinates and to convert them into commands for an operating system, which may either be part of the processing unit 140 or stored in the memory 160.

Especially, the processing unit 140 comprises prestored series of display coordinates which are associated with a certain gesture, i.e. a certain shape described by the movement of either the user's finger over the display 120 or an item, such as a pen, moving over the surface of the display 120. Additionally, these gestures may chosen to be customized by the user and stored onto the memory 160.

Apart from only detecting certain gestures performed by the user, the processing unit 140 may also comprise the detection of the speed with which a user performs the gesture by, for example, calculating the rate of change of coordinates associated with the signals received from the sensing unit 150. This speed of the gesture may for example be used to control the speed of browsing through text and graphic documents, web pages and other types of documents suitable for browsing.

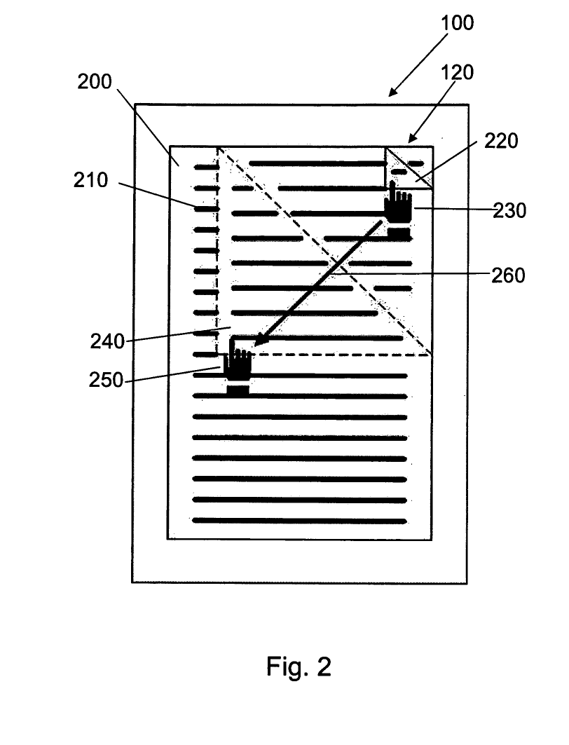

One example of such an application of the speed of the gesture is explained in FIG. 2. The memory 160 in the electronic device may, as already stated above, coordinate sets associated with certain gestures of the user and also certain speed vectors associated with the speed with which the gesture is performed by the user. It will be possible to use any kind of memory suitable for storing information, such as a RAM (Random Access Memory), FlashROM (Flash Read Only Memory), memory cards of different types, microdrives, hard disk and other types of memories, which may be internal to the electronic device 100 or external.

Turning now to FIG. 2, the display of the electronic device 100 from FIG. 1 is shown. While in this case the display is showing an electronic document 200 containing text 210, it may display documents containing images, a combination of images and text and basically any document suitable to be viewed on the display 120 of the electronic device 100.

In the upper right corner of the display 120 of the electronic device 100 a pointer 230 in the form of a human hand 230 is shown touching an active area 220 of the display 120. The pointer 230 may have any possible shape, but its size should be small enough not to disturb the reading of the text 210 in the electronic document 200. However, the pointer 230 may also be transparent in which case its size will not be of any significant importance.

It may be mentioned here, that the active area 220 of the display 120 is seen when the user has touched and/or pressed the display 120 in the upper right corner. In this example, a touch or press in this area of the display 120 will be interpreted by the processing unit 140 as a touch or press on an active area of the display 120 and as a command to start browsing through the document 210. This may be followed by an animation illustrating the folding of a corner of the document, such as shown in FIG. 2. The size and position of the active area 220 may arbitrary. Also, several such active areas may be incorporated into the display or be document-specific.

If the user continues to drag his finger or a pen from the position where he initially pressed or touched the display 120 towards the position 250, where the movement direction is indicated by the arrow 260 then the processing unit 140 will via the sensing unit 150 detect the movement as change of “touch” coordinates and possibly also the speed of change of these coordinates. This, the processing unit 140 will interpret as a command to turn the corner 220 of the current page of the electronic document 200 to the position indicated by the dashed lines 240. “The grade of turning” of the page may here be dependent on the distance the user has moved his finger and the speed of turning the page may correspond to the speed with which the user moves his finger over the display 120. The processing unit 140 may also save the last position of the area delineated by the dashed lines 240 and react to movements of the user's finger in the direction opposite the arrow 260, by turning back the page displaying an animation where the corner 240 of the page delineated by the dashed lines will become smaller (not shown).

This may occur if the user has not lifted his finger of the display 120 from the position 250 or also if the user has lifted his finger, but touches roughly the same area 250 of the display again.

In this fashion, a user may use the gesture and speed of gesture recognizing function of the electronic unit to interactively flip through documents, web pages, lists and other types of information.

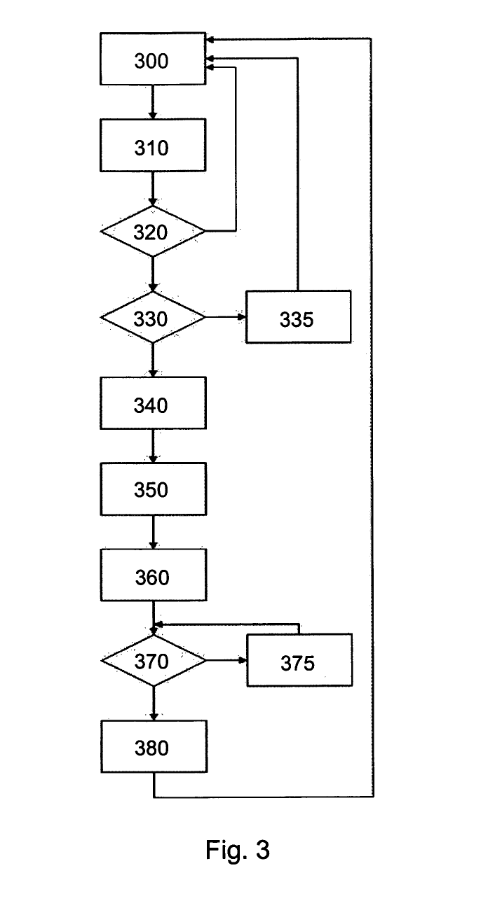

Turning now to FIG. 3, the steps of one embodiment of a method according to the present invention are illustrated.

At step 300, a sensing unit in a contact sensitive electronic device, such as the sensing unit 150 in the electronical device 100 from FIG. 1, registers a contact with display of the electronic device. This may be the display 120 from FIG. 1. Depending on the technology which the sensing unit is based on, the sensing unit may detect a touch or a pressing on the display. Also, the touch or the pressing may be performed by a human finger or by some other suitable item, such as a pen, as preferred.

In the next step, i.e. at step 310, the sensor unit generates signals corresponding to the contact made with the display of the contact sensitive device and sends them to a processing unit in the device, such as, for example, the processing unit 140 in the electronic device 100 from FIG. 1. Depending on the size of the contact area between the item making contact with the display, this may be one, a small number or a larger number of coordinates. The processing unit then converts the signals into coordinates on the display.

At step 320, the processing unit may retrieve coordinates corresponding to one or more active areas on the display and compare these with the coordinates calculated in step 310. If one or more of the calculated coordinates are identical with coordinate range defining one or more active areas on the screen, then at step 330 it is checked whether this active area is a gesture sensitive area where the processing unit can detect the speed with which the gesture is performed.

If that is not the case, then at step 335, the processing unit executes the action associated with the coordinates defining the active area. This may for example comprise closing and opening of a document, start of a new application in the electronic device or some other action. However, it may also be possible to associate certain applications with certain gestures where, once the application is started, the active area for performing a gesture is the entire display of the electronic device. In this fashion, a document, such as a text or a text and graphics document may be browsed through by performing certain gestures anywhere on the display. It may also be possible for the user to define these gestures.

Now, if at step 330, the processing unit has detected that the touched or pressed active are is a gesture sensitive area, then it will continue to receive signals from the sensing unit at step and to convert them into display coordinates at step 340. This change of coordinates will be detected by the processing as a gesture at step 350 by comparing the coordinate change with some predefined coordinate changes stored in the memory of the electronic device representing different gestures associated with the gesture sensitive active area detected at step 330. At the same time, the processing unit will at step 360 initiate appropriate action and output this action as, for example, an animation on the display. Thus, when for instance the user uses a gesture “turn the page” by pressing or touching a corner on a document displayed on the display of the electronic device and by dragging his finger or some other item over the surface of the display from the corner of the document to the opposite corner, the processing unit will start an animation on the display of the electronic device showing the first page of the document being folded and turned, such as illustrated in FIG. 2 simulating a turning of the page resembling the situation in the real world.

This may also be done with a web browser where several web pages are open at the same time but placed under each other or with a photo album comprising a number of photographs placed under each other. One other possibility may be a book where the running of pages may be initiated both from, for example, the edge of the left book page towards the right or by the edge of the right book page towards the left. Also, the processing unit may detect the speed of change of the coordinates associated with the gesture sensitive area and initiate an animation matching this change of coordinates. Thus, the speed of turning a page in a document will then depend on the speed with which the user is dragging his finger or some other item over the surface of the display of the electronic device.

Now, at step 370 the processing unit checks whether the user has lifted his finger of the surface of the display, i.e. by not receiving any signals from the sensing unit. In one variant, if the user has not lifted his finger, i.e. the processing unit will continue to receive signals from the sensing unit and the processing unit will at step 375 will continue to output the animation of the document and return to step 370. This should occur if the processing unit still receives signals from the sensor unit indicating movement of the users finger.

In one other variant, if the processing unit receives no change of signals from the sensor unit, indicating that the user has stopped moving his finger, the processing unit may stop the animation of the document on the display of the electronic device. However, if the user continues to move his finger again after stopping, the processing unit may continue with outputting the animation of a document page.

If however, the processing unit detects that the user has lifted his finger of the surface of the electronic device at step 370, then it may either initiate an animation of the document page back to the original position, such as for example from the position 250 to the position 230 in FIG. 2. In one other variant, the processing unit may simply stop the animation of the document page at the time the user lifts his finger of the surface of the display and continue to output the animation once the user makes contact with the surface of the display and starts moving his finger further from the position at which he lifted his finger.

There are several variations that are possible to make to the present invention. According to one variation, the user may be touching, while in the process of turning a page, another area of the display where the page that is in the process of being turned will end up. The user may here perform the turning of pages using his index finger and the touching of this other area with his thumb. The area touched will then be used for creating a bookmark for the turned page that is presented on the display, either at the area being touched or somewhere else on the display. It will then be possible for the user to quickly go back to the originally turned page through touching the bookmark.

It may be remarked, that while the above description elaborates on the example of browsing through documents by means of gestures or the speed of gestures, the present invention may apply to all kinds of actions on a contact sensitive display which may be operated by a gesture or the speed of that gesture performed by a finger of user or by an item making contact with the display.

1. An electronic device comprising:
a display for receiving contact between a human finger or another item and a contact sensitive area on the display;
a sensing unit for registering the contact with the display and for converting the contact into electrical signals;
a processing unit for calculating coordinates associated with the display from the electrical signals received from the sensing unit, for comparing the received coordinates with predefined coordinates stored in a memory indicative of gesture sensitive areas on the display, the processing unit being further configured for browsing an electronic document, wherein the browsing is responsive to the speed with which the gesture is performed by a human finger or another item in contact with the display and wherein each electronic document displayed in the display is associable with its own set of gestures.

2. A method for operating an electronic device by means of contact comprising the steps:
a) registering a contact between a human finger or another item and a contact sensitive display;
b) calculating coordinates on the contact sensitive display from the contact registered;
c) comparing the calculated coordinates with predefined coordinates associated with a gesture sensitive area on the contact sensitive display;
d) associating one of more specific gestures performed by a human finger or another item over the surface of the display with one or more specific electronic documents displayed on the display;
e) detecting the speed of movement with which the specific gesture performed by a human finger or another item is performed over the surface of the display and;
f) initiating a browsing of the electronic document, wherein the browsing is responsive to the speed with which the gesture is performed on the display.

3. A computer program for operating an electronic device sensitive to contact comprising instruction sets for:
a) registering a contact between a human finger or another item and a contact sensitive display;
b) calculating coordinates on the contact sensitive display from the contact registered;
c) comparing the calculated coordinates with predefined coordinates associated with a gesture sensitive area on the contact sensitive display;
d) associating one or more specific gestures performed by a human finger or another item over the surface of the display with one or more specific electronic documents displayed on the display;
e) detecting the speed of movement with which the specific gesture performed by a human finger or another item is performed over the surface of the display and;
f) initiating a browsing of the electronic document, wherein the browsing is responsive to the speed with which the gesture is performed on the display.
